(19) United States
(12) Patent Application Publication
(10) Pub. No.: US 2024/0274980 A1
(43) Pub. Date: Aug. 15, 2024

(54) FUNCTIONALIZED SEPARATOR WITH LITHIUM-ION CONDUCTING SOLID ELECTROLYTE AND CAPACITOR MATERIAL

(71) Applicant: GM GLOBAL TECHNOLOGY OPERATIONS LLC, Detroi, MI (US)

(72) Inventors: Zhe LI, Shanghai (CN); Meiyuan WU, Shanghai (CN); Qili SU, Shanghai (CN); Dave G. Rich, Sterling Heights, MI (US); Yong Lu, Shanghai (CN); Haijing LIU, Shanghai (CN)

(21) Appl. No.: 18/365,377

(22) Filed: Aug. 4, 2023

(30) Foreign Application Priority Data
Feb. 14, 2023 (CN) 202310114797.7

(51) Int. Cl. H01M 50/457; H01G 11/52; H01M 10/052; H01M 10/0562; H01M 50/414; H01M 50/446

(52) U.S. Cl. CPC H01M 50/457; H01G 11/52; H01M 10/052; H01M 10/0562; H01M 50/414; H01M 50/446; H01M 2300/0068

(57) ABSTRACT

A functionalized separator for a battery cell includes a separator layer including a first side and a second side. A functionalized layer is arranged on at least one of the first side and the second side of the separator layer. The functionalized layer comprises a lithium-ion conducting solid electrolyte and a capacitor active material.

### CROSS-REFERENCE TO RELATED APPLICATIONS

This application claims the benefit of Chinese Patent Application No. 202310114797.7, filed on Feb. 14, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including a functionalized separator with lithium-ion conducting electrolyte and capacitor material.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased energy and power density to increase the performance of the EVs.

### SUMMARY

A functionalized separator for a battery cell includes a separator layer including a first side and a second side. A functionalized layer is arranged on at least one of the first side and the second side of the separator layer. The functionalized layer comprises a lithium-ion conducting solid electrolyte and a capacitor active material.

In other features, a polymer layer arranged on the functionalized layer. The separator layer is selected from a group consisting of polyolefin, cellulose, polyvinylidene fluoride (PVDF), polyethylene terephthalate, polytetrafluoroethylene, polyvinylidenefluoride-hexafluoropropylene, and polyimide. The functionalized layer comprises a first coating/layer including the lithium-ion conducting solid electrolyte arranged on the first side of the separator layer and a second coating/layer including the capacitor active material arranged on the first coating/layer.

In other features, the functionalized layer comprises a first coating/layer including the capacitor active material arranged on the first side of the separator layer and a second coating/layer including the lithium-ion conducting solid electrolyte arranged on the first coating/layer. The functionalized layer comprises one or more coating/layers including a mixture of the lithium-ion conducting solid electrolyte, the capacitor active material and a binder arranged on the first side of the separator layer. The second side of the separator layer includes a coating/layer including a lithium-ion conducting solid electrolyte. The second side of the separator layer includes a coating/layer including a capacitor active material.

In other features, the first coating/layer includes the capacitor active material in a range from 80 to 99 wt % and a binder in a range from 1 wt % to 20 wt %. The capacitor active material has a size in a range from 0.02 μm to 50 μm. The capacitor active material is selected from a group consisting of activated carbon, graphene, carbon nanotubes, conducting polymer, soft carbon, hard carbon, metal oxide/sulfide, porous carbon materials, metal-organic framework, and covalent organic framework. The separator layer has a porosity in a range from 10% to 95%. The lithium ion-conducting solid electrolyte is selected from a group consisting of oxide-based solid electrolyte, metal-doped solid electrolyte, aliovalent-substituted solid electrolyte, sulfide-based solid electrolyte, nitride-based solid electrolyte, hydride-based electrolyte, halide-based electrolyte, and borate-based electrolyte.

A battery cell comprises an anode electrode and a cathode electrode. The anode electrode and the cathode electrode exchange lithium ions. The functionalized separator of is arranged between the anode electrode and the cathode electrode.

In other features, the anode electrode includes anode active material in a range from 30 to 98 wt %, solid electrolyte in a range from 1 to 50 wt %, a conductive additive in a range from 1 to 30 wt %, and a binder in a range from 1 to 20 wt %. The cathode electrode includes cathode active material in a range from 30 to 98 wt %, solid electrolyte in a range from 1 to 50 wt %, a conductive additive in a range from 1 to 30 wt %, and a binder in a range from 1 to 20 wt %.

A battery cell comprises an anode electrode and a cathode electrode. The anode electrode and the cathode material exchange lithium ions. A functionalized separator is arranged between the anode electrode and the cathode electrode. The functionalized separator comprises a separator layer including a first side and a second side. A functionalized layer is arranged on at least one of the first side and the second side of the separator layer. The functionalized layer comprises a lithium-ion conducting solid electrolyte and a capacitor active material. The separator layer is selected from a group consisting of polyolefin, cellulose, polyvinylidene fluoride—(PVDF), polyethylene terephthalate, polytetrafluoroethylene, polyvinylidenefluoride-hexafluoropropylene, and polyimide. The lithium ion-conducting solid electrolyte is selected from a group consisting of oxide-based solid electrolyte, metal-doped solid electrolyte, aliovalent-substituted solid electrolyte, sulfide-based solid electrolyte, nitride-based solid electrolyte, hydride-based electrolyte, halide-based electrolyte, and borate-based electrolyte. The capacitor active material is selected from a group consisting of activated carbon, graphene, carbon nanotubes, conducting polymer, soft carbon, hard carbon, metal oxide/sulfide, porous carbon materials, metal-organic frameworks, and covalent organic frameworks.

In other features, the functionalized layer comprises a first coating/layer including the lithium-ion conducting solid electrolyte arranged on the first side of the separator layer and a second coating/layer including the capacitor active material arranged on the first coating/layer.

In other features, the functionalized layer comprises a first coating/layer including the capacitor active material arranged on the first side of the separator layer and a second coating/layer including the lithium-ion conducting solid electrolyte arranged on the first coating/layer.

In other features, the functionalized layer comprises one or more coating/layers including a mixture of the lithium-ion conducting solid electrolyte, the capacitor active material and a binder arranged on the first side of the separator layer. The second side of the separator layer includes one of a coating/layer including a lithium-ion conducting solid electrolyte and a coating/layer capacitor active material.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A to 1F are side cross-sectional views of examples of functionalized separators according to the present disclosure;

FIGS. 2A to 2C are side cross-sectional views of examples of battery cells including functionalized separators including a solid electrolyte coating/layer and a capacitor active material coating/layer according to the present disclosure;

FIGS. 3A to 3E are side cross-sectional views of examples of functionalized separators including a coating/layer including a mixture of solid electrolyte and a capacitor active material according to the present disclosure; and

FIGS. 4A to 4C are side cross-sectional views of functionalized separators including a polymer layer according to the present disclosure.

In the drawings, reference numbers may be reused to identify similar and/or identical elements.

### DETAILED DESCRIPTION

While the battery cells are described herein in the context of EVs, the battery cells can be used in stationary applications and/or in other applications.

Porous polyolefin separators in lithium-ion battery cells are used to separate anode electrodes and cathode electrodes. The separators play a key role in ion transport and influence cell safety and rate performance. The battery cell is subjected to various types of abuse including mechanical, electrical, and/or thermal abuse. Mechanical abuse includes nail penetration or crushing that may cause deformation and/or fracture of the separator. Electrical abuse includes piercing of the separator caused by dendrite growth induced during excessive charging and/or discharging. Thermal abuse may occur after extreme high temperature operation causing the shrinkage and/or collapse of the separator and/or internal short circuits (ISC).

When operating in abusive conditions, the separator may fail (e.g., fracture, shrinkage, and/or collapse) and cause internal short circuits (ISC) and thermal runaway. To avoid thermal runaway, mechanical and thermal stability of lithium-ion separators are typically enhanced. However, increasing the mechanical and thermal stability of the separator typically increases internal cell resistance, which adversely affects battery performance.

A battery cell according to the present disclosure includes anode electrodes, cathode electrodes, and functionalized separators arranged between the anode electrodes and the cathode electrodes. The anode electrodes include an anode current collector and an anode coating/layer arranged on one or both sides of the anode current collector. The anode coating/layer includes an anode active material, a conductive additive, and a binder. The cathode electrodes include a cathode current collector and a cathode coating/layer arranged on one or both sides of the cathode current collector. The cathode coating/layer includes a cathode active material, a conductive additive, and a binder. The coating/layer can comprise a coating applied to another layer and/or a free-standing layer.

In some examples, the functionalized separator includes a separator layer (e.g., polypropylene (PP)), a first coating/layer comprising a lithium-ion conducting solid electrolyte (e.g., Li_{1.4}Al_{0.4}Ti_{1.6}(PO₄)₃ (LATP)), and a second coating/layer comprising a capacitor active material (e.g., activated carbon (AC)). The lithium-ion conducting solid electrolyte coating/layer physically separates the cathode and anode electrodes and ensures electrical isolation (e.g., during normal operation and/or failure of the separator). The capacitor active material coating/layer provides ion adsorbing/desorbing functionality to improve the rate performance and power response of the battery cell.

The lithium-ion conducting solid electrolyte of the functionalized separator improves the battery thermal stability, physically separates the cathode and/or anode electrode, and ensures electrical isolation during normal operation and failure modes. The lithium-ion conducting solid electrolyte enhances rate capability and low-temperature performance. The lithium-ion conducting solid electrolyte promotes the dissociation of Li salt and boosts the lithium-ion transportation. The capacitor active material provides quick ion adsorbing and desorbing at high current rate to improve the rate performance and power response of the battery cell.

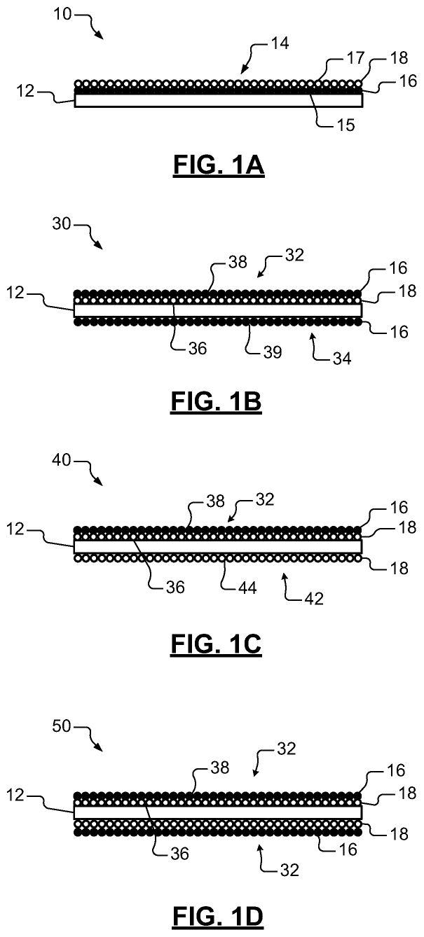

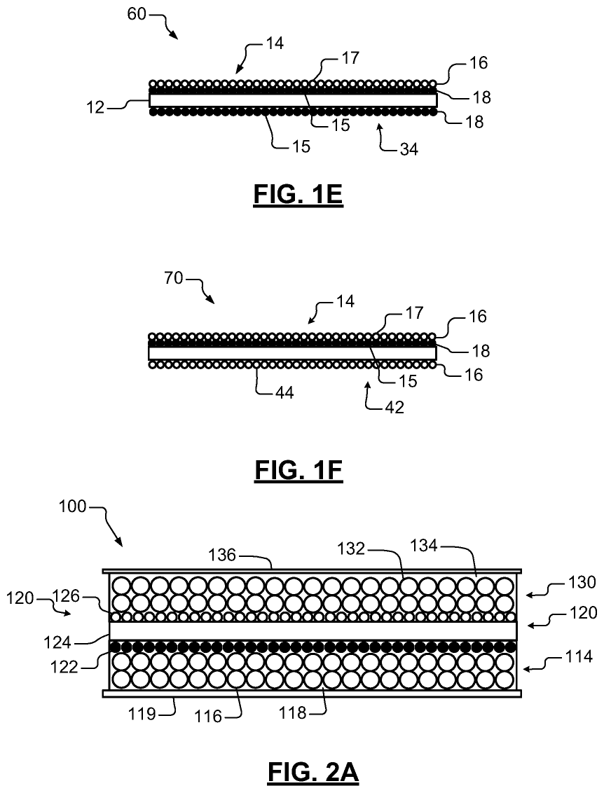

Referring now to FIGS. 1A to 1F, various examples of functionalized separators according to the present disclosure are shown. In FIG. 1A, a functionalized separator 10 includes a separator layer 12 and a functionalized layer 14 arranged on one or both sides of the separator layer 12. The functionalized layer 14 includes a first coating/layer 15 including a capacitor active material 16 arranged on the separator layer 12. A second coating/layer 17 includes a lithium-ion conducting solid electrolyte material 18 arranged on the first coating/layer 15.

In FIG. 1B, a functionalized separator 30 includes the separator layer 12 and functionalized layers 32 and 34 arranged on one or both sides of the separator layer 12. The functionalized layer 32 is arranged on a first side of the separator layer 12 and includes a first coating/layer 36 including the lithium-ion conducting solid electrolyte material 18 and a second coating/layer 38 including the capacitor active material 16. The functionalized layer 34 is arranged on a second side of the separator layer 12 and includes a third coating/layer 39 including the capacitor active material 16.

In FIG. 1C, a functionalized separator 40 includes the separator layer 12 and functionalized layers 32 and 42 arranged on opposite sides of the separator layer 12. The functionalized layer 32 is arranged on a first side of the separator layer 12 and includes the first coating/layer 36 including the lithium-ion conducting solid electrolyte material 18 and the second coating/layer 38 including the capacitor active material 16. The functionalized layer 42 is arranged on the opposite side of the separator layer 12 and includes a third coating/layer 44 including the lithium-ion conducting solid electrolyte material 18.

In FIG. 1D, a functionalized separator 50 includes the separator layer 12 and the functionalized layer 32 arranged on opposite sides of the separator layer 12. The functionalized layer 32 includes the first coating/layer 36 including the lithium-ion conducting solid electrolyte material 18 and the second coating/layer 38 including the capacitor active material 16.

In FIG. 1E, a functionalized separator 60 includes the separator layer 12 and the functionalized layers 14 and 34 (as described above) arranged on opposite sides of the separator layer 12. In FIG. 1F, a functionalized separator 70 includes the separator layer 12 and the functionalized layers 14 and 42 (as described above) arranged on opposite sides of the separator layer 12.

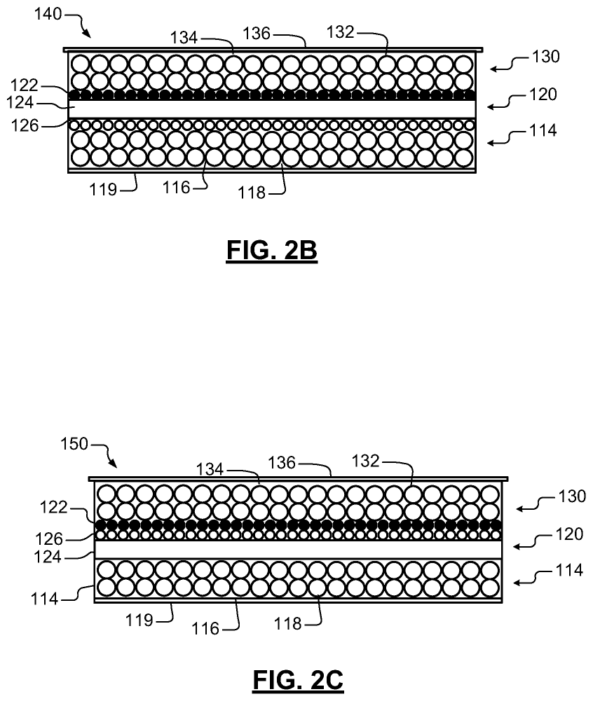

Referring now to FIGS. 2A to 2C, examples illustrating battery cells including functionalized separators are shown. While specific examples are shown, any of the functionalized separators shown and described herein may be used. In FIG. 2A, a battery cell 100 includes an anode electrode 114, a functionalized separator layer 120, and a cathode electrode 130. The functionalized separator layer 120 includes a separator layer 124 with a lithium-ion conducting solid electrolyte coating/layer 126 on the cathode side and a capacitor active material coating/layer 122 on the anode side. The pores in functionalized separator layer 120 are also occupied by liquid electrolyte.

The anode electrode 114 includes anode active material 116 and a liquid electrolyte 118 arranged on one or both sides of an anode current collector 119. A cathode electrode 130 includes cathode active material 132 and liquid electrolyte 134 arranged on one or both sides of the cathode current collector 136.

In FIG. 2B, a battery cell 140 includes the lithium-ion conducting solid electrolyte coating/layer 126 arranged on the separator layer 124 between the separator layer 124 and the anode electrode 114. The capacitor active material coating/layer 122 is arranged between the separator layer 124 and the cathode electrode 130.

In FIG. 2C, a battery cell 150 includes the lithium-ion conducting solid electrolyte coating/layer 126 and the capacitor active material coating/layer 122 arranged on the separator layer 124 between the separator layer 124 and the cathode electrode 130. As can be appreciated, any of the other functionalized separators shown and described herein can be used.

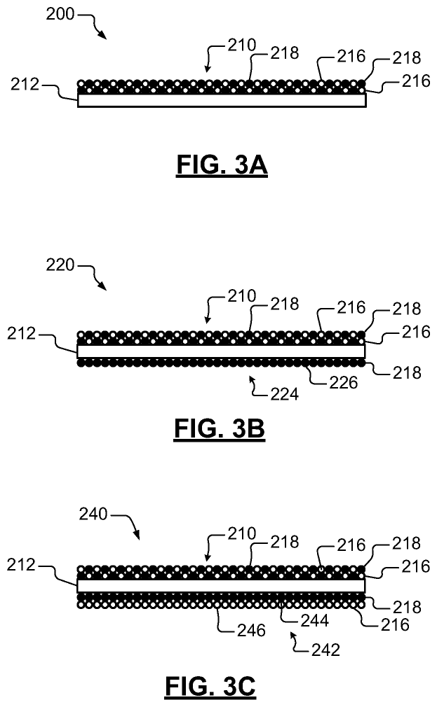

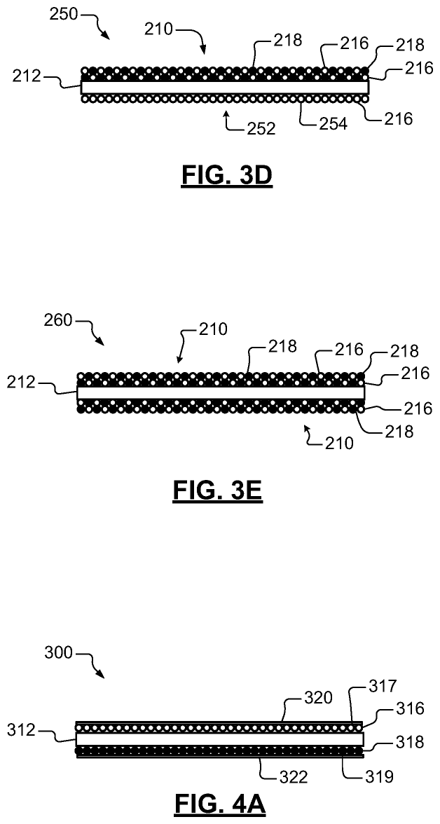

Referring now to FIGS. 3A to 3E, additional examples of functionalized separators are shown. The functionalized separators include one or more coatings/layers comprising a mixture of lithium-ion conducting solid electrolyte and capacitor active material. In FIG. 3A, a functionalized separator 200 includes a separator 212 and a functionalized layer 210. The functionalized layer 210 is arranged on a first side of the separator 212. The functionalized layer 210 comprises a mixture of lithium-ion conducting solid electrolyte 216 and a capacitor active material 218.

In FIG. 3B, a functionalized separator 220 includes the separator 212, the functionalized layer 210, and a functionalized layer 224. The functionalized layer 210 (as described above) is arranged on a first side of the separator 212. The functionalized layer 224 includes a coating/layer 226 including the capacitor active material 218 arranged on a second side of the separator 212.

In FIG. 3C, a functionalized separator 240 includes the separator 212, the functionalized layer 210, and a functionalized layer 242. The functionalized layer 210 (as described above) is arranged on a first side of the separator 212. The functionalized layer 242 further includes a first coating/layer 244 arranged on a second side of the separator 212 and including the capacitor active material 218. The functionalized layer 242 further includes a second coating/layer 246 including the lithium-ion conducting solid electrolyte 216 arranged on the first coating/layer 244.

In FIG. 3D, a functionalized separator 250 includes the separator 212, the functionalized layer 210, and a functionalized layer 252. The functionalized layer 210 (as described above) is arranged on a first side of the separator 212. A functionalized layer 252 includes a first coating/layer 254 including the lithium-ion conducting solid electrolyte 216 arranged on a second side of the separator 212.

In FIG. 3E, a functionalized separator 260 includes the separator 212 and the functionalized layer 210 arranged on opposite sides of the separator 212.

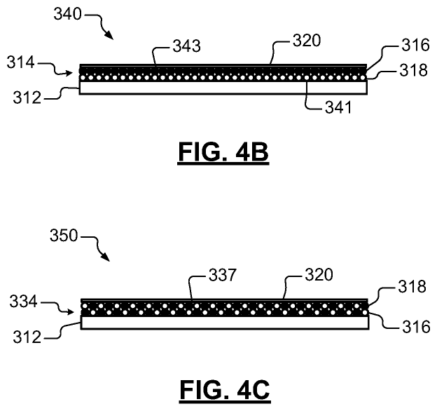

Referring now to FIGS. 4A to 4C, the functionalized separators may further include a polymer layer arranged on one or both sides thereof. In FIG. 4A, a functionalized separator 300 includes a separator 312 including a first coating/layer 317 including a lithium-ion conducting solid electrolyte 316 arranged on a first side. A polymer layer 320 is arranged on the first coating/layer 317. The separator 312 includes a second coating/layer 319 including a capacitor active material 318 arranged on a second side. A polymer layer 322 is arranged on the second coating/layer 319.

In FIG. 4B, a functionalized separator 340 includes the separator 312 and a functionalized layer 314 arranged between the separator 312 and the polymer layer 320. The functionalized layer 314 includes a first coating/layer 341 including the lithium-ion conducting solid electrolyte 316 and a second coating/layer 343 including the capacitor active material 318.

In FIG. 4C, a functionalized separator 350 includes the separator 312 and a functionalized layer 334 arranged between the separator 312 and the polymer layer 320. The functionalized layer 334 includes a coating/layer 337 including a mixture of the lithium-ion conducting solid electrolyte 316 and the capacitor active material 318.

In some examples, the separator layer 212 has a thickness in a range from 1 to 50 μm (e.g., 8 μm to 10 μm). In some examples, the solid electrolyte coating/layer has a thickness in a range from 0.5 μm to 30 μm (e.g., 3 μm). In some examples, the capacitor active material coating/layer has a thickness in a range 0.5 μm to 30 μm (4 μm).

In some examples, the separator layer has a porosity of 10% to 95% (e.g., 55%). In some examples, the separator layer comprises a material selected from a group consisting of polyolefin, cellulose, polyvinylidene fluoride (PVDF), polyethylene terephthalate, polytetrafluoroethylene, polyvinylidenefluoride-hexafluoropropylene, polyimide membrane, and other porous film. In some examples, the polyolefin-based separator is selected from a group consisting of polyacetylene:polypropylene (PP), polyethylene (PE), dual-layer type: PP-PE, or a three-layer type: PP-PE-PP.

In some examples, the capacitor active material layer comprises capacitor active material and a binder. In some examples, the capacitor active material comprises 80 wt % to 100 wt % of the capacitor active material layer and have a size in a range from 0.02 μm to 50 μm. In some examples, the binder comprises 0 wt % to 20 wt % of the capacitor active material layer.

In some examples, the capacitive active material selected from a group consisting of activated carbon, graphene, carbon nanotubes (CNTs), conducting polymer (e.g., PEDOT), soft carbon, hard carbon, metal oxide/sulfide (e.g., TiO₂), porous carbon materials, metal-organic frameworks (MOFs), and covalent organic frameworks. In some examples, the binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS) and so on.

In some examples, the solid electrolyte layer in the functionalized separator comprises solid electrolyte and binder. In some examples, the binder comprises 0 wt % to 20 wt %. In some examples, the solid electrolyte comprises 80 wt % to 100 wt %. In some examples, the solid electrolyte has a diameter in a range from 0.02 μm to 20 μm.

In some examples, the solid electrolyte layer in the functionalized separator and/or the electrodes is selected from a group consisting of oxide-based solid electrolyte, metal-doped or aliovalent-substituted solid electrolyte, sulfide-based solid electrolyte, nitride-based solid electrolyte, hydride-based electrolyte, halide-based electrolyte, and borate-based electrolyte.

Examples of oxide-based solid electrolyte include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃and Li₁₊ₓ AlₓGe₂₋ₓ(PO₄)₃), and LISICON type (e.g., Li₂₊₂ₓZn₁₋ₓGeO₄).

Examples of metal-doped or aliovalent-substituted oxide solid electrolyte include Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, and Al-substituted perovskite,_{1+x+y}AlₓTi₂₋ₓSi_{y}P_{3-y}O₁₂.

Examples of sulfide-based solid electrolyte include Li₂S-P₂S₅ system, Li₂S-P₂S₅-MO_{X} system, Li₂S-P₂S₅-MSₓ system, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (X═Cl, Br, or I), Li_{9.54}Si_{1.74}P_{1.44}S_{11.7}Cl_{0.3} (25 mS/cm), Li_{9.6}P₃S₁₂, Li₇P₃S₁₁, Li₉P₃S₉O₃,Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.166}S₄, LiI—Li₄SnS₄, and Li₄SnS₄.

Examples of nitride-based solid electrolyte include Li₃N, Li₇PN₄, LiSi₂N₃. Examples of hydride-based solid electrolyte include LiBH₄, LiBH₄—LiX (X═Cl, Br, or I), LiNH₂, Li₂NH, LiBH₄—LiNH₂, and Li₃AlH₆. Examples of halide-based solid electrolyte include LiI, Li₃InCl₆, Li₂CdCl₄, Li₂MgCl₄, Li₂CdI₄, Li₂ZnI₄, and Li₃ Ocl. Examples of borate-based solid electrolyte include Li₂B₄O₇ and Li₂O—B₂O₃—P₂O₅.

In some examples, the electrodes comprising electrode active material (30˜98 wt %), conductive additive (0˜30 wt %), and binder(0˜20 wt %). In some examples, the cathode active material is selected from a group consisting of a layered oxide represented by the formula LiMeO₂, an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMe₂PO₄F, or a combination thereof, where Me is a transition metal (e.g., Co, Ni, Mn, Fe, Al, V, or a combination thereof).

In some examples, the anode active material is selected from a group consisting of carbonaceous material (e.g., graphite, hard carbon, soft carbon etc.), silicon, silicon mixed with graphite, Li₄Ti₅O₁₂, transition-metal (e.g., Sn), metal oxide/sulfide (e.g., TiO₂, FeS and the likes), Li metal and Li alloy, and other lithium-accepting anode materials.

In some examples, the conductive additive comprises carbon black, graphite, graphene, graphene oxide, Super P, acetylene black, carbon nanofibers, carbon nanotubes and other electronically conductive additives.

In some examples, the binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS) and so on.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A functionalized separator for a battery cell, comprising:
a separator layer including a first side and a second side; and
a functionalized layer arranged on at least one of the first side and the second side of the separator layer, wherein the functionalized layer comprises a lithium-ion conducting solid electrolyte and a capacitor active material.

2. The functionalized separator of claim 1, further comprising a polymer layer arranged on the functionalized layer.

3. The functionalized separator of claim 1, wherein the separator layer is selected from a group consisting of polyolefin, cellulose, polyvinylidene fluoride (PVDF), polyethylene terephthalate, polytetrafluoroethylene, polyvinylidenefluoride-hexafluoropropylene, and polyimide.

4. The functionalized separator of claim 1, wherein the functionalized layer comprises:
a first coating/layer including the lithium-ion conducting solid electrolyte arranged on the first side of the separator layer; and
a second coating/layer including the capacitor active material arranged on the first coating/layer.

5. The functionalized separator of claim 1, wherein the functionalized layer comprises:
a first coating/layer including the capacitor active material arranged on the first side of the separator layer; and
a second coating/layer including the lithium-ion conducting solid electrolyte arranged on the first coating/layer.

6. The functionalized separator of claim 1, wherein the functionalized layer comprises one or more coating/layers including a mixture of the lithium-ion conducting solid electrolyte, the capacitor active material and a binder arranged on the first side of the separator layer.

7. The functionalized separator of claim 1, wherein the second side of the separator layer includes a coating/layer including a lithium-ion conducting solid electrolyte.

8. The functionalized separator of claim 1, wherein the second side of the separator layer includes a coating/layer including a capacitor active material.

9. The functionalized separator of claim 4, wherein the first coating/layer includes the capacitor active material in a range from 80 to 99 wt % and a binder in a range from 1 wt % to 20 wt %.

10. The functionalized separator of claim 9, wherein the capacitor active material has a size in a range from 0.02 μm to 50 μm.

11. The functionalized separator of claim 9, wherein the capacitor active material is selected from a group consisting of activated carbon, graphene, carbon nanotubes, conducting polymer, soft carbon, hard carbon, metal oxide/sulfide, porous carbon materials, metal-organic framework, and covalent organic framework.

12. The functionalized separator of claim 1, wherein the separator layer has a porosity in a range from 10% to 95%.

13. The functionalized separator of claim 1, wherein the lithium ion-conducting solid electrolyte is selected from a group consisting of oxide-based solid electrolyte, metal-doped solid electrolyte, aliovalent-substituted solid electrolyte, sulfide-based solid electrolyte, nitride-based solid electrolyte, hydride-based electrolyte, halide-based electrolyte, and borate-based electrolyte.

14. A battery cell comprising:
an anode electrode;
a cathode electrode,
wherein the anode electrode and the cathode electrode exchange lithium ions; and
the functionalized separator of claim 1 arranged between the anode electrode and the cathode electrode.

15. The battery cell of claim 14, wherein:
the anode electrode includes cathode active material in a range from 30 to 98 wt %, solid electrolyte in a range from 1 to 50 wt %, a conductive additive in a range from 1 to 30 wt %, and a binder in a range from 1 to 20 wt %; and
the cathode electrode includes anode active material in a range from 30 to 98 wt %, solid electrolyte in a range from 1 to 50 wt %, a conductive additive in a range from 1 to 30 wt %, and a binder in a range from 1 to 20 wt %.

16. A battery cell comprising:
an anode electrode;
a cathode electrode,
wherein the anode electrode and the cathode material exchange lithium ions; and
a functionalized separator arranged between the anode electrode and the cathode electrode, wherein the functionalized separator comprises:
a separator layer including a first side and a second side; and
a functionalized layer arranged on at least one of the first side and the second side of the separator layer,
wherein the functionalized layer comprises a lithium-ion conducting solid electrolyte and a capacitor active material,
wherein the separator layer is selected from a group consisting of polyolefin, cellulose, polyvinylidene fluoride (PVDF), polyethylene terephthalate, polytetrafluoroethylene, polyvinylidenefluoride-hexafluoropropylene, and polyimide,
wherein the lithium ion-conducting solid electrolyte is selected from a group consisting of oxide-based solid electrolyte, metal-doped solid electrolyte, aliovalent-substituted solid electrolyte, sulfide-based solid electrolyte, nitride-based solid electrolyte, hydride-based electrolyte, halide-based electrolyte, and borate-based electrolyte, and
wherein the capacitor active material is selected from a group consisting of activated carbon, graphene, carbon nanotubes, conducting polymer, soft carbon, hard carbon, metal oxide/sulfide, porous carbon materials, metal-organic frameworks, and covalent organic frameworks.

17. The battery cell of claim 16, wherein the functionalized layer comprises:
a first coating/layer including the lithium-ion conducting solid electrolyte arranged on the first side of the separator layer; and
a second coating/layer including the capacitor active material arranged on the first coating/layer.

18. The battery cell of claim 16, wherein the functionalized layer comprises:
a first coating/layer including the capacitor active material arranged on the first side of the separator layer; and
a second coating/layer including the lithium-ion conducting solid electrolyte arranged on the first coating/layer.

19. The battery cell of claim 16, wherein the functionalized layer comprises one or more coating/layers including a mixture of the lithium-ion conducting solid electrolyte, the capacitor active material and a binder arranged on the first side of the separator layer.

20. The battery cell of claim 16, wherein the second side of the separator layer includes one of:
a coating/layer including a lithium-ion conducting solid electrolyte; and
a coating/layer including a capacitor active material.
